(19) United States
(12) Patent Application Publication
(10) Pub. No.: US 2016/0371473 A1
(43) Pub. Date: Dec. 22, 2016

(54) Code Obfuscation Device Using Indistinguishable Identifier Conversion And Method Thereof

(71) Applicant: Soongsil University Research Consortium Techno-Park, Seoul (KR)

(72) Inventors: Jeong-Hyun Yi, Seongnam-si (KR); Sung-Ryoung Kim, Seoul (KR); Geon-Bae Na, Seoul (KR); Yong-Jin Park, Seoul (KR)

(73) Assignee: Soongsil University Research Consortium Techno-Park, Seoul (KR)

(21) Appl. No.: 15/104,310

(22) PCT Filed: Mar. 6, 2015
(86) PCT No.: PCT/KR2015/002197

§ 371 Date: Jun. 14, 2016

(30) Foreign Application Priority Data
Jan. 8, 2015 (KR) 10-2015-0002933

(51) Int. Cl. G06F 21/12; G06F 21/14

(52) U.S. Cl. CPC G06F 21/12; G06F 21/14; G06F 2221/0748

(57) ABSTRACT

A code obfuscation device and a method of obfuscating a code of an application program file are disclosed. The code obfuscation device includes an extraction circuit uncompressing an application program file to extract a Dalvik executable file, a code analysis circuit analyzing a bytecode of the Dalvik executable file, a control circuit determining an obfuscation character and a number and a location of the obfuscation character to be inserted in the bytecode, and an identifier conversion circuit inserting the obfuscation character in the bytecode to convert an identifier of the bytecode. Since the identifier of the bytecode is converted using an obfuscation character, which corresponds to a character that is invisible on a screen or has a different Unicode from another character displayed on the screen as a same shape as the character, the application program file has an increased resistance to a reverse engineering attack.

### THE ART TO WHICH THE INVENTIVE CONCEPT

Example embodiments generally relate to a code obfuscation device and a method of obfuscating a code, and more particularly relate to a code obfuscation device and a method of obfuscating a code using an indistinguishable identifier conversion to protect an application program from a reverse engineering attack.

### BACKGROUND OF THE INVENTIVE CONCEPT

JAVA program is translated into a bytecode, and the bytecode is executed on any kinds of machines supporting a JAVA virtual machine since the bytecode uses a JAVA virtual machine which is not dependent on a particular machine. Since information of a JAVA source code is included in the bytecode as it is, a decompiling from the bytecode to the JAVA source code is performed easily. Similarly, an Android application implemented with a JAVA language is decompiled easily to restore a source code, which is similar to an original source code.

Generally, an Android application program package (APK) is decompiled to comprehend a source code, such that a reverse engineering attack or a cracking on the Android application program package is possible. In this regard, a code obfuscation technology may be used. If a code obfuscation technology is applied, a source code may not be comprehended by a decompilation, such that the source code may be protected from a reverse engineering attack or a cracking.

Here, the code obfuscation represents a technology to change a program code in a certain manner for making it hard to analyze a binary code or a source code with a reverse engineering.

The code obfuscation may be divided into a source code obfuscation and a binary code obfuscation based on a compiled form of a program to be obfuscated. The source code obfuscation represents a technology to change a program source code, which is written by a program language such as C, C++, JAVA, etc., into an illegible form, and the binary code obfuscation represents a technology to change a binary code, which is generated by compiling the program source code written by a program language such as C, C++, JAVA, etc., into an illegible form. Since a compiled code of JAVA, which is referred to as a bytecode, includes more information required for a reverse engineering than a native code, a reverse engineering is easily performed on the byte code. Therefore, the code obfuscation technology has been applied on the bytecode.

The code obfuscation technology includes an identifier conversion, a control flow, a character string encryption, an application programming interface (API) hiding, a class encryption, etc. The identifier conversion represents a technology to change a class name, a field name, or a method name into a meaningless name having no relation with an original name for making it hard to analyze a decompiled source code. For example, an identifier may be converted by a command shortening technology.

Although a meaning of an identifier is hidden by the identifier conversion, a converted identifier may be used as a visually unique identifier while performing a reverse engineering. Therefore, an attacker may easily recognize the unique identifier, such that the identifier conversion may not have a high resistance to a reverse engineering attack.

The background art of the present invention has been described in Korean Patent Registration No. 10-1328012 (Nov. 13, 2013).

### CONTENT OF THE INVENTIVE CONCEPT

### Technical Object of the Inventive Concept

Some example embodiments of the inventive concept provide a code obfuscation device and a method of obfuscating a code using an indistinguishable identifier conversion to protect an application program from a reverse engineering attack.

### Means for Achieving the Technical Object

According to example embodiments, a code obfuscation device includes an extraction circuit uncompressing an application program file to extract a Dalvik executable file, a code analysis circuit analyzing a bytecode of the Dalvik executable file, a control circuit determining an obfuscation character and a number and a location of the obfuscation character to be inserted in the bytecode, and an identifier conversion circuit inserting the obfuscation character in the bytecode to convert an identifier of the bytecode.

In some example embodiments, the extraction circuit may uncompress the application program file to extract the bytecode of the Dalvik executable file.

In some example embodiments, the obfuscation character may correspond to a character which is invisible on a screen or has a different Unicode from another character displayed on the screen as a same shape as the character.

In some example embodiments, the identifier conversion circuit may insert the obfuscation character in at least one of a class name, a method name, and a field name of the bytecode.

In a method of obfuscating a code of an application program file, the application program file is uncompressed to extract a Dalvik executable file, a bytecode of the Dalvik executable file is analyzed, an obfuscation character and a number and a location of the obfuscation character is determined to be inserted in the bytecode, and the obfuscation character is inserted in the bytecode to convert an identifier of the bytecode.

### Effects of the Inventive Concept

Since an identifier of a bytecode of an application program file is converted using an obfuscation character, which corresponds to a character that is invisible on a screen or has a different Unicode from another character displayed on the screen as a same shape as the character, the application program file has an increased resistance to a reverse engineering attack based on a static analysis.

In addition, since a confusion of an attacker is caused by the obfuscation characters having different Unicodes from each other while being displayed on the screen as a same shape, the application program file has an increased resistance to a reverse engineering analysis. Further, since a binary file analysis ability is required for a reverse engineering attack, the application program file has an increased resistance to a reverse engineering analysis.

In addition, since the code obfuscation technology is applied to the application program file, a technology leakage by an analysis of the application program file or a tampering of the application program file is prevented, such that the application program file is protected from various kinds of attacks.

### BRIEF DESCRIPTION OF THE DRAWINGS

FIG. 1 is a block diagram illustrating a code obfuscation device using an identifier conversion according to example embodiments.

FIG. 2 is a flow chart illustrating a method of obfuscating a code of an application program file using an identifier conversion according to example embodiments.

FIG. 3 is a diagram for describing the method of obfuscating a code of an application program file of FIG. 2.

FIG. 4 is a diagram for describing an increased resistance to a reverse engineering analysis of the method of obfuscating a code of an application program file of FIG. 2.

### PARTICULAR CONTENTS FOR IMPLEMENTING THE INVENTIVE CONCEPT

Various example embodiments will be described more fully with reference to the accompanying drawings, in which some example embodiments are shown. The present inventive concept may, however, be embodied in many different forms and should not be construed as limited to the embodiments set forth herein. Rather, these embodiments are provided so that this disclosure will be thorough and complete, and will fully convey the scope of the present inventive concept to those skilled in the art. Like reference numerals refer to like elements throughout this application.

It will be understood that the term “circuit”, when used herein, specifies a unit performing at least one function or an operation, which is implemented with a hardware, a software, or a combination of a hardware and a software.

Hereinafter, various example embodiments will be described fully with reference to the accompanying drawings.

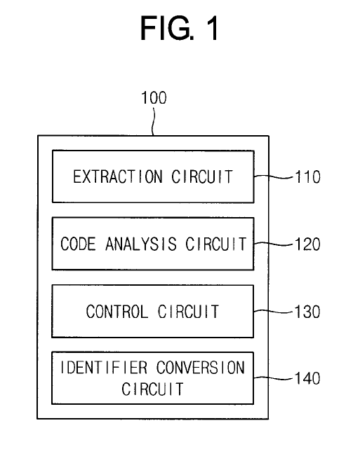

FIG. 1 is a block diagram illustrating a code obfuscation device using an identifier conversion according to example embodiments.

Referring to FIG. 1, a code obfuscation device 100 includes an extraction circuit 110, a code analysis circuit 120, a control circuit 130, and an identifier conversion circuit 140.

The extraction circuit 110 may uncompress an application program file to extract a Dalvik executable (DEX) file. In some example embodiments, the application program file may correspond to an Android application program package (APK) file, and the extraction circuit 110 may uncompress the APK file to extract a bytecode of the DEX file.

The code analysis circuit 120 may analyze the bytecode of the DEX file.

The control circuit 130 may determine an obfuscation character and a number and a location of the obfuscation character to be inserted in the bytecode. In some example embodiments, the obfuscation character may correspond to a character which is invisible on a screen or has a different Unicode from another character displayed on the screen as a same shape as the character.

The identifier conversion circuit 140 may insert the obfuscation character in the bytecode to convert an identifier of the bytecode. In some example embodiments, the identifier conversion circuit 140 may insert the obfuscation character in at least one of a class name, a method name, and a field name of the bytecode. In addition, the identifier conversion circuit 140 may rebuild the bytecode including the obfuscation character.

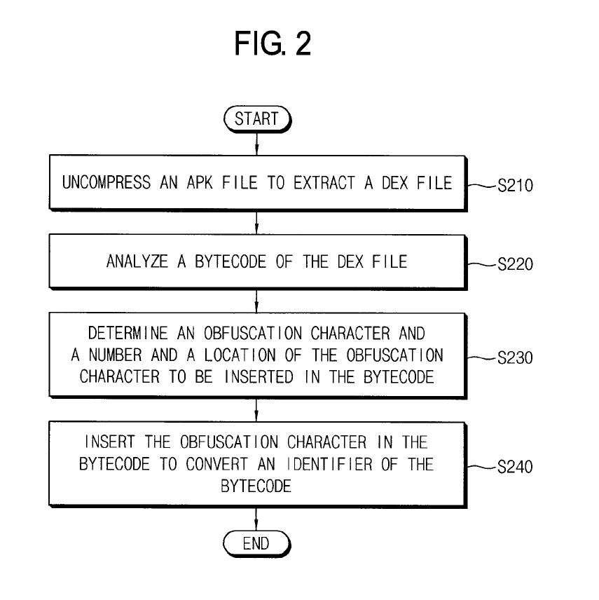

Hereinafter, a method of protecting an application program according to example embodiments will be described with reference to FIGS. 2 to 4.

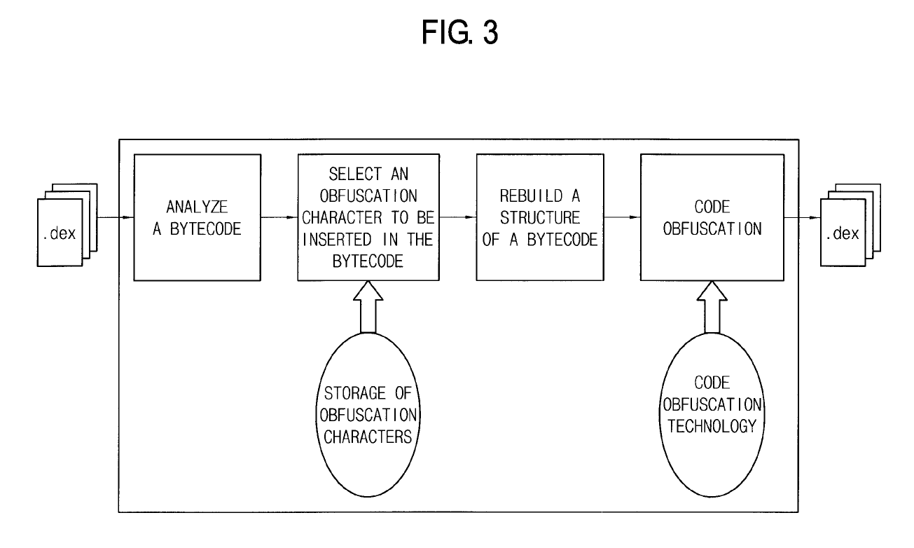

FIG. 2 is a flow chart illustrating a method of obfuscating a code of an application program file using an identifier conversion according to example embodiments, and FIG. 3 is a diagram for describing the method of obfuscating a code of an application program file of FIG. 2.

The extraction circuit 110 may uncompress an APK file, which corresponds to an application program file, to extract a DEX file (S210).

The APK file represents a compressed package having a form of ZIP file which is used for a distribution and an installation of an application on an Android operating system. A user may obtain the APK file using a file management application such as an Android debug bridge (ADB) included in an Android software development kit (SDK), an ASTRO file manager, a file expert, an ES file explorer, etc.

The extraction circuit 110 may uncompress the APK file using an uncompressing utility such as a 7-Zip, WinZip, etc., to extract the DEX file. When the APK file is decompressed, files and directories such as classes.dex, AndroidManifest.xml, META-IMF/, res/, resources.arsc, assets/, lib, etc. may be obtained, and the classes.dex file may be the DEX file, which corresponds to a most important file among elements of the APK file.

The classes.dex file may be generated by converting a JAVA bytecode (.class), which is generated by compiling a JAVA code (.java), into a Dalvik executable file format (.dex) to execute the classes.dex file on a Dalvik virtual machine of an Android.

The code analysis circuit 120 may analyze a bytecode of the DEX file (S220). The code analysis circuit 120 may identify classes, methods, fields, etc. included in the DEX file, and select an identifier of the class, the method, the field, etc. in which an obfuscation character is to be inserted.

The control circuit 130 may determine which obfuscation character is to be inserted in the bytecode and a number and a location of the obfuscation character to be inserted in the bytecode (S230).

In some example embodiments, the obfuscation character may correspond to a character which is expressed as a NULL value on a normal text editor while being recognized as a separate character having a unique Unicode by a system. In other example embodiments, the obfuscation character may correspond to a character which has a different Unicode from another character that is expressed as a same shape as the character. Therefore, the obfuscation characters may not be distinguished using the normal text editor but is distinguished using an editor dealing with a binary code such as a hex editor.

TABLE 1

| UTF-8 VALUE | CHARACTER EXPRESSION |
|---|---|
| 0xC2AD | (INVISIBLE) |
| . . . | . . . |
| 0xD7BA | □ |
| 0xD7BB | □ |
| 0xD7BC | □ |
| 0xD7BD | □ |
| . . . | . . . |

As illustrated in [Table 1], if a character is invisible in a normal text editor but is expressed as a soft hyphen in an editor dealing with a binary code such as Alt+0173 in Windows or 0xC2AD in UTF, the character may be used as the obfuscation character.

In addition, as illustrated in [Table 1], if each of a plurality of characters having different codes is expressed as a same shape of □ such that codes of the plurality of characters are not distinguished using the expressed shape, each of the plurality of characters may be used as the obfuscation character. For example, if the obfuscation character, which is expressed as the shape of □, is used, an attacker may not identify which one of 0xD7BA, 0xD7BB, 0xD7BC, and 0xD7BD corresponds to a code value of the obfuscation character. Therefore, an attacker may not distinguish code values of the obfuscation characters on a smali code.

The control circuit 130 may determine a number and a location of the obfuscation character to be inserted in an identifier of the bytecode.

TABLE 2

| PRIOR TO | g | e | t | S | e | c | r | e | t | | |
|---|---|---|---|---|---|---|---|---|---|---|---|
| APPLICATION | 0x67 | 0x65 | 0x74 | 0x53 | 0x65 | 0x63 | 0x72 | 0x65 | 0x74 | | |
| APPLICATION 1 | g | e | t | S | | | e | c | r | e | t |
| | 0x67 | 0x65 | 0x74 | 0x53 | 0xC2 | 0xAD | 0x65 | 0x63 | 0x72 | 0x65 | 0x74 |
| APPLICATION 2 | g | e | t | S | e | c | r | e | t | | |
| | 0x67 | 0x65 | 0x74 | 0x53 | 0x65 | 0x63 | 0x72 | 0x65 | 0x74 | 0xC2 | 0xAD |

As illustrated in [Table 2], when the obfuscation character of 0xC2AD, which is expressed as a NULL value, is determined to be inserted in a method name of ‘getSecret’, the control circuit 130 may determine an insertion location of the obfuscation character as a middle of the method name as illustrated in an application 1 of [Table 1] or as an end of the method name as illustrated in an application 2 of [Table 2].

The control circuit 130 may determine how many number of which obfuscation character is to be inserted in which location of a class name, a method name, of a field name.

TABLE 3

| PRIOR TO | g | e | t | S | e | c | r | e | t | | |
|---|---|---|---|---|---|---|---|---|---|---|---|
| APPLICATION | 0x67 | 0x65 | 0x74 | 0x53 | 0x65 | 0x63 | 0x72 | 0x65 | 0x74 | | |
| APPLICATION 3 | g | e | t | S | e | c | r | e | t | □ | |
| | 0x67 | 0x65 | 0x74 | 0x53 | 0x65 | 0x63 | 0x72 | 0x65 | 0x74 | 0xD7 | 0xBA |
| APPLICATION 4 | g | e | t | S | e | c | r | e | t | □ | |
| | 0x67 | 0x65 | 0x74 | 0x53 | 0x65 | 0x63 | 0x72 | 0x65 | 0x74 | 0xD7 | 0xBB |

In addition, the control circuit 130 may select the obfuscation character, a code value of which is indistinguishable, such as 0xD7BA, 0xD7BB, etc., to be inserted in the identifier of the bytecode. As illustrated in an application 3 and an application 4 of [Table 3], the control circuit 130 may select the obfuscation characters having different code values with each other while the obfuscation characters are expressed as the same shape of

The identifier conversion circuit 140 may insert the selected obfuscation character in the bytecode to convert an identifier of the bytecode (S240). The identifier conversion circuit 140 may insert the obfuscation character, which is selected by the control circuit 130 in the step of S230, in the identifier of the bytecode, which is selected by the code analysis circuit 120 in the step of S220, to convert the identifier of the bytecode.

As illustrated in FIG. 3, after finishing the identifier conversion, the identifier conversion circuit 140 may rebuild a structure of a bytecode to generate a DEX file in which the identifier is converted.

In some example embodiments, the code obfuscation device 100 according to example embodiments may further apply a code obfuscation technology on the bytecode including the converted identifier in the step of S240 using a code obfuscation solution such as a Proguard, a Dexguard, an Allatori, a Stringer Java Obfuscator, etc.

In addition, the code obfuscation device 100 may further apply a source code obfuscation or a binary code obfuscation. For example, the code obfuscation device 100 may further apply a control flow, a character string encryption, an application programming interface (API) hiding, a class encryption, etc.

The control flow may represent a technology in which an ambiguous command or a garbage command, which is hard to be understood, is inserted such that a control flow analysis becomes hard to be performed. The character string encryption may represent a technology in which a particular character string is encrypted and is decrypted using a decryption method when the encrypted character string is executed. The API hiding may represent a technology in which an important library and a method are hidden. The class encryption may represent a technology in which a particular class file is encrypted and is decrypted when the encrypted class file is executed.

In addition, the code obfuscation device 100 may apply a layout obfuscation, a data obfuscation, an aggregation obfuscation, a control obfuscation, etc.

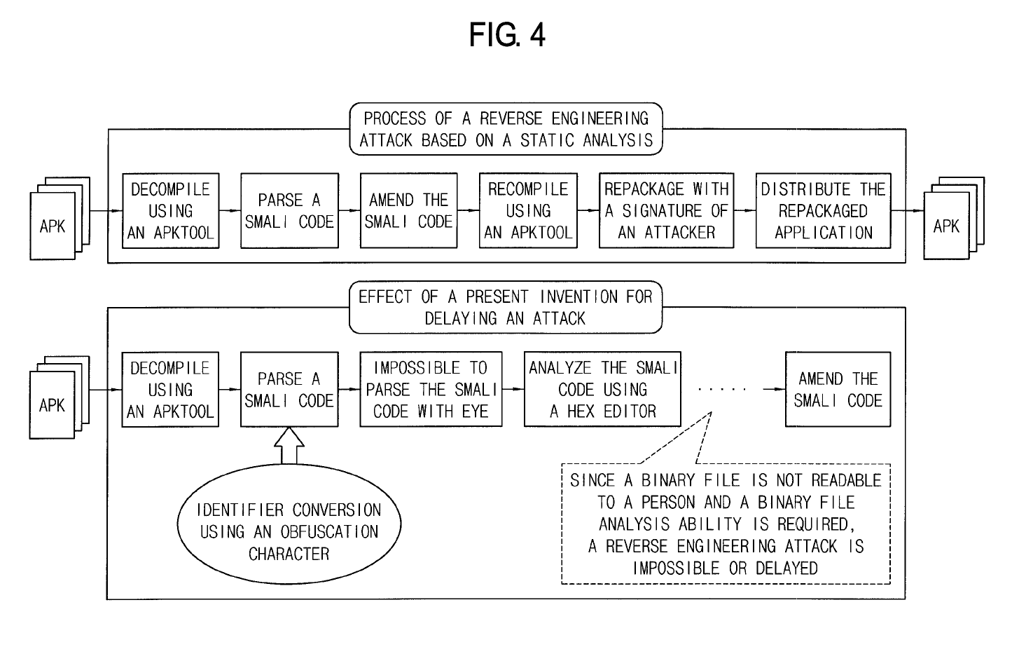

FIG. 4 is a diagram for describing an increased resistance to a reverse engineering analysis of the method of obfuscating a code of an application program file of FIG. 2.

Referring to FIG. 4, when a code obfuscation technology is not used, an attacker may decompile an APK file using an Apktool to extract a smali code written using a Dalvik bytecode and parse the smali code. The attacker may amend the smali code and recompile the amended smali code using an Apktool. The attacker may repackage the recompiled file with a signature of the attacker using an Apktool and distribute the repackaged APK file. In this way, the attacker may generate a tampered application program and distribute the tampered application program.

However, if the method of obfuscating a code of an application program file using an identifier conversion according to example embodiments is used, an attacker may not be able to parse a smali code although the attacker obtains the smali code by decompiling an APK file using an Apktool. Therefore, a time and a cost required to parse the smali code may be increased.

As described above, since an identifier of a bytecode of an application program file is converted using an obfuscation character, which corresponds to a character that is invisible on a screen or has a different Unicode from another character displayed on the screen as a same shape as the character, the application program file may have an increased resistance to a reverse engineering attack based on a static analysis.

In addition, since a confusion of an attacker is caused by the obfuscation characters having different Unicodes from each other while being displayed on the screen as a same shape, the application program file has an increased resistance to a reverse engineering analysis. Further, since a binary file analysis ability is required for a reverse engineering attack, the application program file may have an increased resistance to a reverse engineering analysis.

In addition, since the code obfuscation technology is applied to the application program file, a technology leakage by an analysis of the application program file or a tampering of the application program file may be prevented, such that the application program file may be protected from various kinds of attacks.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

### REFERENCE NUMERALS

100: code obfuscation device

110: extraction circuit

120: code analysis circuit

130: control circuit

140: identifier conversion circuit

What is claimed is:

1. A code obfuscation device, comprising:
an extraction circuit configured to uncompress an application program file to extract a Dalvik executable file;
a code analysis circuit configured to analyze a bytecode of the Dalvik executable file;
a control circuit configured to determine an obfuscation character and a number and a location of the obfuscation character to be inserted in the bytecode; and
an identifier conversion circuit configured to insert the obfuscation character in the bytecode to convert an identifier of the bytecode.

2. The code obfuscation device of claim 1, wherein the extraction circuit uncompresses the application program file to extract the bytecode of the Dalvik executable file.

3. The code obfuscation device of claim 1, wherein the obfuscation character corresponds to a character which is invisible on a screen or has a different Unicode from another character displayed on the screen as a same shape as the character.

4. The code obfuscation device of claim 1, wherein the identifier conversion circuit inserts the obfuscation character in at least one of a class name, a method name, and a field name of the bytecode.

5. A method of obfuscating a code of an application program file using a code obfuscation device, comprising:
uncompressing the application program file to extract a Dalvik executable file;
analyzing a bytecode of the Dalvik executable file;
determining an obfuscation character and a number and a location of the obfuscation character to be inserted in the bytecode; and
inserting the obfuscation character in the bytecode to convert an identifier of the bytecode.

6. The method of claim 5, wherein the uncompressing the application program file to extract the Dalvik executable file from the application program file includes:
uncompressing the application program file to extract the bytecode of the Dalvik executable file.

7. The method of claim 5, wherein the obfuscation character corresponds to a character which is invisible on a screen or has a different Unicode from another character displayed on the screen as a same shape as the character.

8. The method of claim 5, wherein the inserting the obfuscation character in the bytecode to convert the identifier of the bytecode includes:
inserting the obfuscation character in at least one of a class name, a method name, and a field name of the bytecode.
